(19) United States
(12) Patent Application Publication
(10) Pub. No.: US 2004/0115021 A1
(43) Pub. Date: Jun. 17, 2004

(54) Cargo space organizer

(76) Inventor: Jesse J. Carmichael, Buffalo, NY (US)

Correspondence Address: SIMON, GALASSO & FRANTZ PLC., P.O. Box 26503, Austin, TX, 78755-0503, US

(21) Appl. No.: 10/657,340

(22) Filed: Sep. 8, 2003

Related U.S. Application Data
(60) Provisional application No. 60/408,833, filed on Sep. 6, 2002.

(51) Int. Cl. B60P 7/135

(52) U.S. Cl. 410/121

(57) ABSTRACT

A cargo space organizer comprising a first elongated member, a second elongated member, a retention assembly and a plurality of extension members. The retention assembly is attached to a first end of the second elongated member and is configured for engaging a mating retention feature of the first elongated member. The retention assembly enables the second elongated member to be attachable at a plurality of different mounted positions between first and second ends of the first elongated member. A first one of the extension members is repositionably attached to the first end of the first elongated member. A second one of the extension members is repositionably attached to the second end of the second elongated member. Each one of the extension members is repositionable between a plurality of respective positions thereby enabling an overall length of the respective elongated member to be selectively increased or decreased.

### CROSS REFERENCE TO RELATED APPLICATIONS

This application claims priority to co-pending U.S. Provisional Patent Application having Serial No. 60/408,833 filed Sep. 6, 2002 entitled “Car Trunk Organizer”, having a common applicant herewith.

### FIELD OF THE DISCLOSURE

The disclosures herein relate generally to cargo space organizers and more particularly to adjustable, rigid cargo space organizers.

### BACKGROUND OF THE DISCLOSURE

Unrestrained movement of cargo in a cargo space of a vehicle is undesirable for many reasons. For example, the cargo can slide back and forth when the vehicle is in motion, allowing the cargo to become damaged by tipping over and/or being crushed by contact with other items stowed in the cargo space (e.g., tool boxes or wheel jacks). Such unrestrained movement can also distract a driver of the vehicle and can damage the vehicle. In addition to damaging the cargo stowed in the cargo space, these situations can all result in unsafe driving conditions.

Conventional cargo space organizers include cargo nets and straight extension poles. Cargo nets are limited in their ability to prevent heavy items from sliding and to retain relatively small items. While extension poles are better suited for holding relatively heavy items and relatively small items in place, they limit movement along only one axis (e.g., fore-aft or side-to-side).

Therefore, a cargo space organizer that overcomes limitations associated with conventional cargo retaining devices would be useful.

### BRIEF DESCRIPTION OF THE DRAWINGS

FIG. 1 depicts a cargo space organizer in accordance with an embodiment of the disclosures made herein.

FIG. 2 is a cross sectional view taken along the line 2-2 in FIG. 1.

FIG. 3 is a cross sectional view taken along the line 3-3 in FIG. 1.

### DETAILED DESCRIPTION OF THE DRAWINGS

The disclosures made herein relate to a cargo space organizer that provides restrict movement of cargo within a cargo space of a vehicle, that allow for use with cargo of different shape and size, and that can be easily moved from one vehicle to another vehicle. Cargo space organizers in accordance with embodiments of the disclosures made herein, prevent cargo from becoming damaged by sliding, from tipping over and/or being crushed by contact with other items stowed in the cargo space. By eliminating unrestrained movement of cargo, the cargo is no longer a distraction of the driver and damage to the vehicle from movement of the cargo is precluded.

In one embodiment of the disclosures made herein, a cargo space organizer comprises a first elongated member, a second elongated member and a retention assembly. The retention assembly is attached to a first end of the second elongated member and is configured for engaging a mating retention feature of the first elongated member. The retention assembly enables the second elongated member to be attachable at a plurality of different mounted positions between the first and second ends of the first elongated member.

In another embodiment of the disclosures made herein, a cargo space organizer comprises a first elongated, a second elongated member and a plurality of extension members. The second elongated member is repositionably attached at a first end thereof to the first elongated member. A second end of the second elongated member is repositionable between a plurality of mounted positions between first and second ends of the first elongated member. A first one of the extension members is repositionably attached to the first end of the first elongated member. A second one of the extension members is repositionably attached to a second end of the second elongated member. Each one of the extension members is repositionable between a plurality of respective positions thereby enabling an overall length of the respective elongated member to be selectively increased or decreased.

In still another embodiment of the disclosures made herein, a cargo space organizer comprises a first elongated member, a second elongated member, a retention assembly and a plurality of extension members. The retention assembly is attached to a first end of the second elongated member and is configured for engaging a mating retention feature of the first elongated member. The retention assembly enables the second elongated member to be attachable at a plurality of different mounted positions between first and second ends of the first elongated member. A first one of the extension members is repositionably attached to the first end of the first elongated member. A second one of the extension members is repositionably attached to the second end of the second elongated member. Each one of the extension members is repositionable between a plurality of respective positions thereby enabling an overall length of the respective elongated member to be selectively increased or decreased.

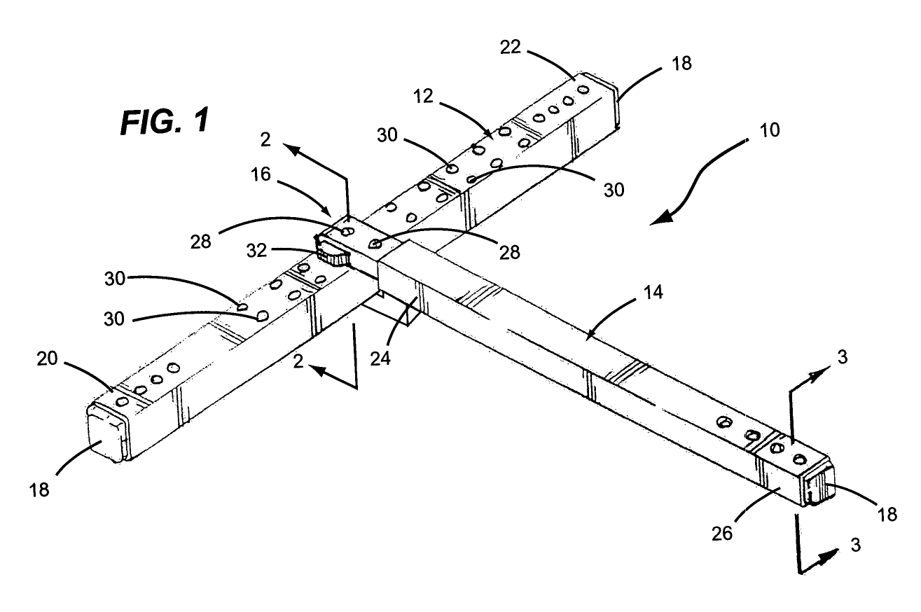

Turning now to specific drawings, FIG. 1 depicts a cargo space organizer 10 in accordance with an embodiment of the disclosures made herein. The cargo space organizer 10 includes a first elongated member 12, a second elongated member 14, a retention assembly 16 and a plurality of extension members 18. The first elongated member 12 has a first end 20 and a second end 22. The second elongated member 14 has a first end 24 and a second end 26.

The retention assembly 16 is attached to the first end 24 of the second elongated member 14 and enables the second elongated member 14 to be attachable at a plurality of different mounted positions between the first end 20 and the second end 22 of the first elongated member 12. The retention assembly 16 includes pins 28 configured for engaging a plurality of longitudinally-spaced paired holes 30 extending through a surface of the first elongated member 12. The pins 28 and holes 30 are jointly configured for enabling the second elongated member 14 to be selectively attachable at the plurality of different mounted positions between the first end 20 and second end 22 of the first elongated member 12.

It is contemplated herein that a single pin may replace the pair of pins and the longitudinally paired holes 30 may be replaced by longitudinally-spaced single holes. One benefit of a plurality of pins 28 is that is limits angular rotation of the first elongated member 12 with respect to the second elongated member 14. The pins 28 are examples of retention members and the holes 30 are examples of mating retention features.

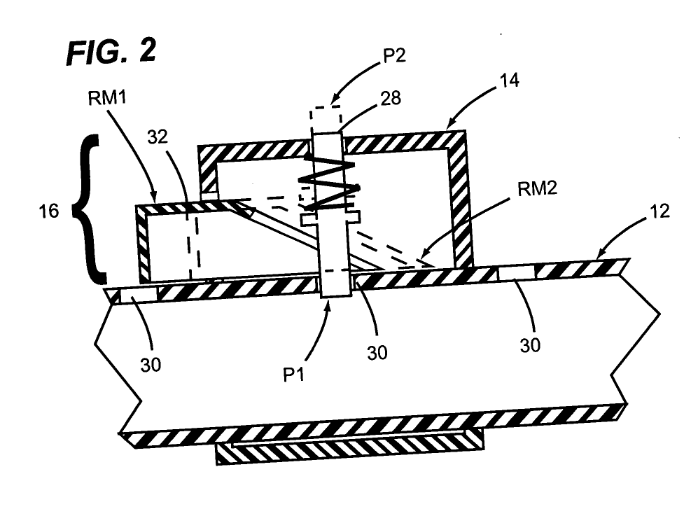

Referring now to FIGS. 1 and 2, the retention assembly 16 includes a release mechanism 32 coupled to each one of the pins 28 (one pin depicted in FIG. 2). Each pin 28 is moved from an engaged position P1 (i.e., engaged with a mating one of the holes 30) to a disengaged position P2 when the release mechanism 32 is moved from an at-rest position RM1 toward a displaced position RM2. Accordingly, the release mechanism 32 enables the pins 28 to be disengaged from the holes 30.

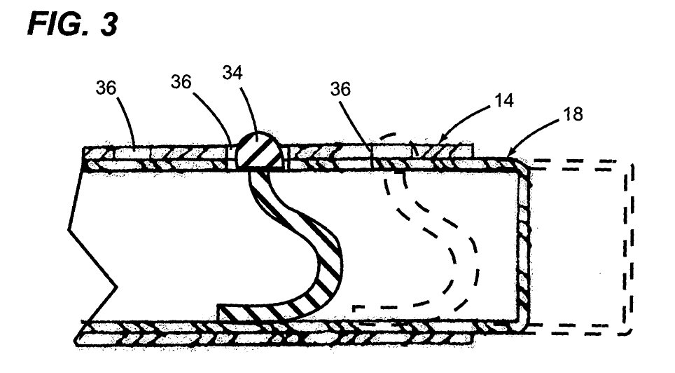

Referring now to FIGS. 1 and 3, the extension members 18 are repositionably attached at the ends of a respective one of the elongated member (12, 14). The extension members 18 are configured to telescope along the end of the respective one of the elongated members (12,14). A spring-loaded pin 34 is mounted on each one of the extension members 18. A plurality of spaced-apart holes 36 extend through a surface of each one of the elongated members extension members (12, 14) where the respective extension member 18 is mounted.

The spaced apart holes 36 are selectively engagable by the respective spring-loaded pin 34. In this manner, the extension members 18 enable an overall length of the respective elongated member to be selectively increased or decreased. The spring-loaded pin 34 and the plurality of holes 36 jointly depict a means for enabling the extension members 18 to be independently repositioned and secured relative to a longitudinal axis of the respective elongated member.

It is contemplated herein that the spring-loaded pin 34 may be mounted on the respective one of the elongated members (12, 14) and the plurality of mating holes 36 may extend through the respective extension member 18 (e.g., the extension member sliding over the respective elongated member rather than within it). It is also contemplated herein that the extension members 18 may be biased outward (e.g., via a spring pushing the extension member outward) in addition to being selectively adjustable.

It is contemplated herein that primary components of the elongated member, extension members and release mechanisms in accordance with embodiments of the disclosures made herein may be made from any one of a variety of known commercially available materials. Examples of such materials include filled and unfilled polymers. Such known materials may be processed using known processing techniques such as injection molding, extrusion, vacuum forming, milling, turning and the like.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A cargo space organizer, comprising:
a first elongated member having a first end and a second end;
a second elongated member having a first end and a second end; and
a retention assembly attached to the first end of the second elongated member and configured for engaging a mating retention feature of the first elongated member, wherein the retention assembly enables the second elongated member to be attachable at a plurality of different mounted positions between the first and second ends of the first elongated member.

2. The cargo space organizer of claim 1 wherein:
the retention assembly includes at least one retention member that engages the mating retention feature of the first elongated member; and
said at least one retention member and the mating retention feature are jointly configured for enabling the second elongated member to be selectively attachable at the plurality of different mounted positions between the first and second ends of the first elongated member.

3. The cargo space organizer of claim 2 wherein:
said at least one retention assembly includes a pin;
the mating retention feature includes a plurality of longitudinally-spaced holes extending through a surface of the first elongated member; and
the pin is selectively engagable with said holes.

4. The cargo space organizer of claim 2 wherein:
said at least one retention member includes a pair of spaced apart pins;
the mating retention feature includes a plurality of longitudinally-spaced paired holes extending through a surface of the first elongated member; and
the pair of spaced apart pins are selectively engagable with said paired holes.

5. The cargo space organizer of claim 1 wherein the retention assembly includes a release mechanism coupled to a retention member, wherein the retention member is moved from an engaged position to a disengaged position when the release mechanism is moved from an at-rest position toward a displaced position, thereby enabling the retention member to be disengaged from the mating retention feature.

6. The cargo space organizer of claim 1, further comprising:
a first extension member repositionably attached to one of said ends of the first elongated member, thereby enabling an overall length of the first elongated member to be selectively increased or decreased; and
a second extension member repositionably attached to the second end of the first elongated member, thereby enabling an overall length of the second elongated member to be selectively increased or decreased.

7. The cargo space organizer of claim 6, further comprising:
means for enabling the first and the second extension members to be independently repositioned and secured relative to a longitudinal axis of the respective elongated member.

8. The cargo space organizer of claim 7 wherein said means includes:
a spring-loaded pin mounted on each one of said elongated members; and
a plurality of spaced-apart holes extending through a surface of each one of said extension members and are selectively engagable by the spring-loaded pin.

9. A cargo space organizer, comprising:
a first elongated member having a first end and a second end;
a second elongated member having a first end and a second end, wherein the second elongated member is repositionably attached at the first end thereof to the first elongated member and wherein the second end of the second elongated member is repositionable between a plurality of mounted positions between the first and second ends of the first elongated member; and
a plurality of extension members, wherein a first one of said extension members is repositionably attached to the first end of the first elongated member, wherein a second one of said extension members is repositionably attached to the second end of the second elongated member, and wherein each one of said extension members is repositionable between a plurality of respective positions thereby enabling an overall length of the respective elongated member to be selectively increased or decreased.

10. The cargo space organizer of claim 9, further comprising:
means for enabling each one of said extension members to be independently repositioned and secured relative to a longitudinal axis of the respective elongated member.

11. The cargo space organizer of claim 10 wherein said means includes:
a spring-loaded pin mounted on each one of said elongated members; and
a plurality of spaced-apart holes extending through a surface of each one of said extension members and are selectively engagable by the spring-loaded pin.

12. The cargo space organizer of claim 9 wherein:
the second elongated member includes at least one retention member configured for enabling the second elongated member to be repositionably attached at the first end thereof to the first elongated member;
said at least one retention member is attached to the first end of the second elongated member and is configured for engaging a mating retention feature of the first elongated member; and
said at least one retention member and the mating retention feature are jointly configured for enabling the second elongated member to be attachable at a plurality of different mounted positions between the first and second ends of the first elongated member.

13. The cargo space organizer of claim 12 wherein:
said at least one retention member includes a pin;
the mating retention feature includes a plurality of longitudinally-spaced holes extending through a surface of the first elongated member; and
the pin is selectively engagable with said holes.

14. The cargo space organizer of claim 12 wherein:
said at least one retention member includes a pair of spaced apart pins;
the mating retention feature includes a plurality of longitudinally-spaced paired holes extending through a surface of the first elongated member; and
the pair of spaced apart pins are selectively engagable with said paired holes.

15. The cargo space organizer of claim 12, further comprising:
a release mechanism coupled to said at least one retention member, wherein said at least one retention member is moved from an engaged position to a disengaged position when the release mechanism is moved from an at-rest position toward a displaced position, thereby enabling said at least one retention member to be disengaged from the mating retention feature.

16. A cargo space organizer, comprising:
a first elongated member having a first end and a second end;
a second elongated member having a first end and a second end;
a retention assembly attached to the first end of the second elongated member and configured for engaging a mating retention feature of the first elongated member, wherein the retention assembly enables the second elongated member to be attachable at a plurality of different mounted positions between the first and second ends of the first elongated member; and
a plurality of extension members, wherein a first one of said extension members is repositionably attached to the first end of the first elongated member, wherein a second one of said extension members is repositionably attached to the second end of the second elongated member, and wherein each one of said extension members is repositionable between a plurality of respective positions thereby enabling an overall length of the respective elongated member to be selectively increased or decreased.

17. The cargo space organizer of claim 16 wherein:
the retention assembly includes at least one retention member that engages the mating retention feature of the first elongated member; and
said at least one retention member and the mating retention feature are jointly configured for enabling the second elongated member to be attachable at a plurality of different mounted positions between the first and second ends of the first elongated member.

18. The cargo space organizer of claim 17 wherein:
said at least one retention assembly includes a pin;
the mating retention feature includes a plurality of longitudinally-spaced holes extending through a surface of the first elongated member; and
the pin is selectively engagable with said holes.

19. The cargo space organizer of claim 18, further comprising:
a release mechanism coupled to the pin, wherein the pin is moved from an engaged position to a disengaged position when the release mechanism is moved from an at-rest position toward a displaced position.

20. The cargo space organizer of claim 19, further comprising:
means for enabling said extension members to be independently repositioned relative to a longitudinal axis of the respective elongated member and secured in place on the respective elongated member.
